(19) United States
(12) Patent Application Publication
(10) Pub. No.: US 2026/0348856 A1
(43) Pub. Date: Nov. 5, 2026

(54) SYSTEM FOR MEASURING AT LEAST ONE CHEMICAL COMPONENT OF A FLOWING FLUID FOR AN ELECTROCHEMICAL-GENERATOR SYSTEM

(71) Applicant: HORIBA FRANCE SAS, PALAISEAU (FR)

(72) Inventors: Guillaume DUCOURTHIAL, PALAISEAU (FR); Sébastien LEGENDRE, PALAISEAU (FR); Christophe FAVEEUW, PALAISEAU (FR); Thibault BRULÉ, PALAISEAU (FR); Jérôme TARDIEU, PALAISEAU (FR)

(21) Appl. No.: 19/486,485

(22) PCT Filed: May 22, 2024
(86) PCT No.: PCT/EP2024/064127

§ 371 Date: Nov. 21, 2025

(30) Foreign Application Priority Data
May 25, 2023 (FR) 2305216
Jan. 17, 2024 (FR) 2400472

(51) Int. Cl. G01N 21/65; G01J 3/02; G01J 3/44; G01N 21/03; G01N 21/05; G01N 21/85

(52) U.S. Cl. CPC G01N 21/65; G01J 3/021; G01J 3/4412; G01N 21/031; G01N 21/05; G01N 21/85; G01N 2021/0314; G01N 2021/651; G01N 2021/8578; G01N 2201/06113

(57) ABSTRACT

The invention relates to a system (100) for measuring at least one chemical component of a flowing fluid for an electrochemical-generator system, the measuring system comprising:
a light source (111) generating a light beam,
a double-pass measurement cell (120) comprising an inlet opening (121) configured to let the fluid enter, an outlet opening configured to let the fluid exit, and two portholes placed on a path of the fluid, said portholes being positioned facing each other on a main optical axis transverse to the flow of the fluid and being configured to transmit the light beam,
a reflective optical device (130) positioned to reflect the light beam in the direction of the flowing fluid through the portholes, and
a Raman spectrometer (112) configured to receive the light beam, with a view to detecting a Raman signal emitted by the flowing fluid and to deducing therefrom a measurement of at least one chemical component of the flowing fluid.

### TECHNICAL FIELD OF THE INVENTION

The present invention generally relates to the measurement of fluid concentration, particularly gas concentration.

The invention more particularly relates to a system for measuring at least one chemical component of a flowing fluid for an electrochemical generator system of the fuel cell or electrolyser type.

The invention finds a particularly advantageously application in the measurement of gas entering and/or leaving such an electrochemical generator system.

### STATE OF THE ART

An electrochemical generator system of the fuel cell type makes it possible to generate electrical energy from oxidation of fuel. This fuel is hydrogen, for example. The result is thus the generation of electricity from hydrogen.

Conversely, an electrochemical generator system of the electrolyser type makes it possible to generate a chemical component from electrical energy. For example, an electrochemical generator system comprising an electrolytic cell based on water electrolysis makes it possible, thanks to electrical energy, to generate hydrogen and oxygen. The result is thus the generation of hydrogen.

In order to be able to characterise the state of such an electrochemical generator system in operation and thus estimate the performance in real time, it may be interesting to measure the concentrations of the different chemical elements entering and/or leaving the electrochemical generator system.

Nowadays, solutions consist of extracting part of the gas at the electrochemical generator system inlet or outlet and analysing said gas with or without destruction of the sample extracted.

Gas extraction, and all the more so when it is destroyed during analysis, causes disruptions in the electrochemical generator system operation. When the gas extracted is not destructed but reinjected into the gas circuit, this causes, for example, disruption in the measurement timing.

Moreover, gas extraction may cause pressure and temperature changes that destabilize the gas and may generate measurement errors.

Finally, nowadays, many measuring systems use infrared, which is not compatible with fluids containing a high level of water vapour.

In order to perform the measurements in real time, it is also important to be able to obtain a high measurement frequency, and therefore a good signal-to-noise ratio, in order to reduce the integration time.

### DISCLOSURE OF THE INVENTION

In order to remedy the above-mentioned drawbacks of the state of the art, the present invention proposes a system for measuring a fluid entering or leaving an electrochemical generator system, the measuring system operating in real time and without extraction or isolation of said fluid from the circuit of the electrochemical generator system.

More particularly, according to the invention, it is proposed a system for measuring at least one chemical component of a flowing fluid for an electrochemical generator system, the measuring system comprising:
a Raman spectrometry apparatus comprising a light source, a Raman spectrometer comprising a detection system and a processing system, the light source being configured to generate an excitation light beam,
a double-pass measuring cell comprising a fluid conduit having an inlet opening configured to let the flowing fluid enter and an outlet opening configured to let the flowing fluid exit, the measuring cell comprising a first tight porthole and a second tight porthole, the two portholes being arranged laterally on the fluid conduit downstream from the inlet opening and upstream from the outlet opening, the two portholes being positioned facing each other on a main optical axis transverse to the fluid conduit and being configured to receive the excitation light beam and transmit a first light beam formed by scattering and/or simple transmission of the excitation light beam through the flowing fluid in the fluid conduit, and
an at least partially reflective optical device positioned to receive the first light beam transmitted by the two portholes and configured to reflect the first light beam towards the flowing fluid through the two portholes to form a second light beam formed by scattering and/or double transmission of the excitation light beam through the flowing fluid and the two portholes,
   the Raman spectrometer being configured to receive the second light beam, the detection system being adapted for detecting a Raman signal emitted by the flowing fluid and the processing system being adapted for deducing a measurement of at least one chemical component of the flowing fluid.

Thus, thanks to the invention, the Raman spectrometer makes it possible to analyse the flowing fluid in the continuity of its flowing when the flowing fluid is in the double-pass cell, with no deviation nor extraction. The measuring system then does not disturb the fluid and makes it possible to perform measurements in line directly on the flowing fluid conduit, with no flow interruption nor fluid pressurising.

Moreover, the facing portholes in the double-pass cell as well as the arrangement of said portholes with the optical device on the main optical axis allows the measuring system to take up a minimum of space.

Finally, the arrangement the measuring system and the double-pass cell enables a double excitation of the fluid as well as a better signal-to-noise ratio. This noisy signal makes it possible to have a frequency of acquisition in real time of between 0.1 hertz (Hz) and 100 Hz, e.g. 1 Hz. The noisy signal enables very accurate measurements making it possible in particular to detect very low quantities of fluid, e.g. dinitrogen from 100 ppm to 500 ppm, with no fluid recirculation nor fluid pressurizing.

In an embodiment, the measuring cell is connected to a flowing fluid-conveying conduit at the inlet or the outlet of an electrochemical generator system.

For example, the measuring cell is connected to an outlet of an electrochemical generator system of the electrolyser type, in particular for hydrogen generation, and the Raman spectrometry apparatus is adapted for measuring the concentration of at least one chemical component among water, e.g. as water vapour, dinitrogen, dihydrogen and dioxygen.

As an alternative or as a complement, the measuring cell is connected to an inlet or an outlet of an electrochemical generator system of the hydrogen fuel cell type, for generation of electricity from hydrogen, and the Raman spectrometry apparatus is adapted for measuring the concentration of at least one chemical component among water, dinitrogen, dihydrogen and dioxygen.

Advantageously, the inlet opening and outlet opening of the measuring cell is connected via a conduit for conveying the flowing fluid to the electrochemical generator system.

Advantageously, the inlet opening cross-section and outlet opening cross-section of the measuring cell are each greater than or equal to the cross-section of the flowing fluid-conveying conduit of the electrochemical generator system.

Advantageously, an optical system is arranged between the light source and the first porthole, the optical system being configured to focus the excitation light beam into the measuring cell, between the two portholes.

According to a particular and advantageous aspect, the at least partially reflective optical device is configured to reflect and focus the first light beam into the measuring cell, between the two portholes.

According to another particular and advantageous aspect, the measuring cell comprises at least one thermal unit configured to maintain the first porthole and/or the second porthole at a temperature higher than or equal to a threshold temperature.

Optionally, the first porthole comprises a first glass sheet and the second porthole comprises a second glass sheet, the first, respectively second, glass sheet being made from a glass among borosilicate glass, aluminosilicate glass or alkali-aluminosilicate glass. Advantageously, the measuring system comprises a second measuring cell and the Raman spectrometry apparatus comprises another light source suitable for emitting another excitation light beam, the detection system comprising a light sensor including pixels arranged in several rows and configured to detect simultaneously the Raman signal induced by the light source and a second Raman signal emitted by the flowing fluid when the flowing fluid is excited by the other excitation light beam.

The invention also relates to a system for measuring at least one fluid entering and/or leaving an electrochemical generator system, the measuring system operating in real time and without extraction or isolation of said fluids from the circuit of the electrochemical generator system.

More particularly, according to the invention, it is proposed a system for measuring at least one chemical component of a flowing fluid for an electrochemical generator system, comprising a plurality of fluid inlet and/or outlet conduits, the measuring system comprising:
a Raman spectrometry apparatus comprising a light source, a Raman spectrometer comprising a detection system and a processing system, the light source being configured to generate an excitation light beam, a beam splitter arranged so as to receive the excitation light beam and to form a plurality of split excitation light beams,
a plurality of double-pass measuring cells each arranged on a fluid inlet or outlet conduit of the electrochemical generator system, each double-pass measuring cell comprising a fluid conduit having an inlet opening configured to let enter the flowing fluid coming from said fluid inlet or outlet conduit of the electrochemical generator system and an outlet opening configured to let the flowing fluid exit, each measuring cell comprising a first tight porthole and a second tight porthole, the two portholes of each measuring cell being arranged laterally on the fluid conduit downstream from the inlet opening and upstream from the outlet opening, the two portholes of each measuring cell being positioned facing each other on a main optical axis transverse to the fluid conduit and being configured to receive the excitation light beam and transmit a first light beam formed by scattering and/or simple transmission of the excitation light beam through the flowing fluid in the fluid conduit, and
an at least partially reflective optical device positioned so as to receive the first light beam transmitted by the two portholes and configured to reflect the first light beam towards the flowing fluid through the two portholes to form a second light beam formed by scattering and/or double transmission of the excitation light beam through the flowing fluid and the two portholes,
   the Raman spectrometer being configured to receive the second light beam from each double-pass measuring cell, the detection system being adapted for detecting separately a Raman signal emitted by the flowing fluid of each double-pass measuring cell and the processing system being adapted for deducing therefrom a measurement of at least one chemical component of the flowing fluid in each double-pass measuring cell.

Obviously, the different features, alternatives and embodiments of the invention can be associated with each other according to various combinations, insofar as they are not incompatible or exclusive with respect to each other.

### DETAILED DESCRIPTION OF THE INVENTION

The following description in relation with the appended drawings, given by way of non-limiting examples, will allow a good understanding of what the invention consists of and of how it can be implemented.

In the appended drawings:

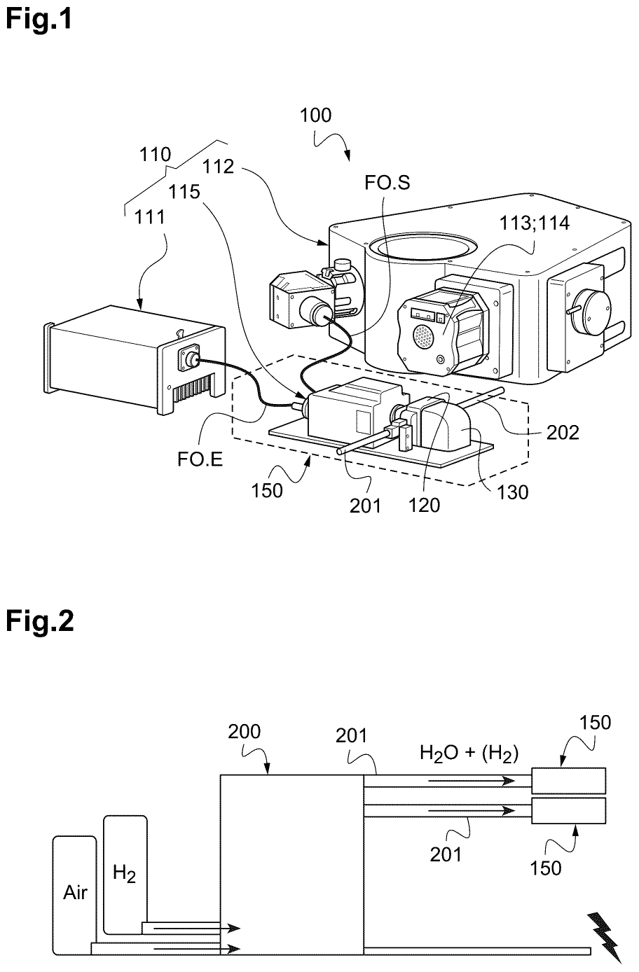

FIG. 1 is a schematic view of a measuring system according to an embodiment of the invention;

FIG. 2 is a schematic view of part of the measuring system in application on an electrochemical generator system of the fuel cell type;

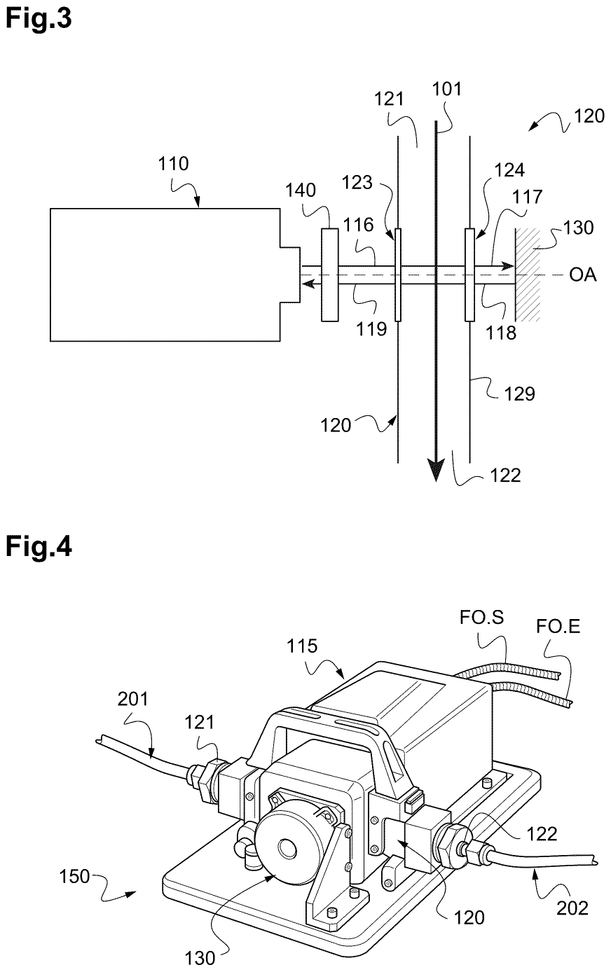

FIG. 3 is a schematic view of part of the measuring system;

FIG. 4 is a schematic view of part of the measuring system;

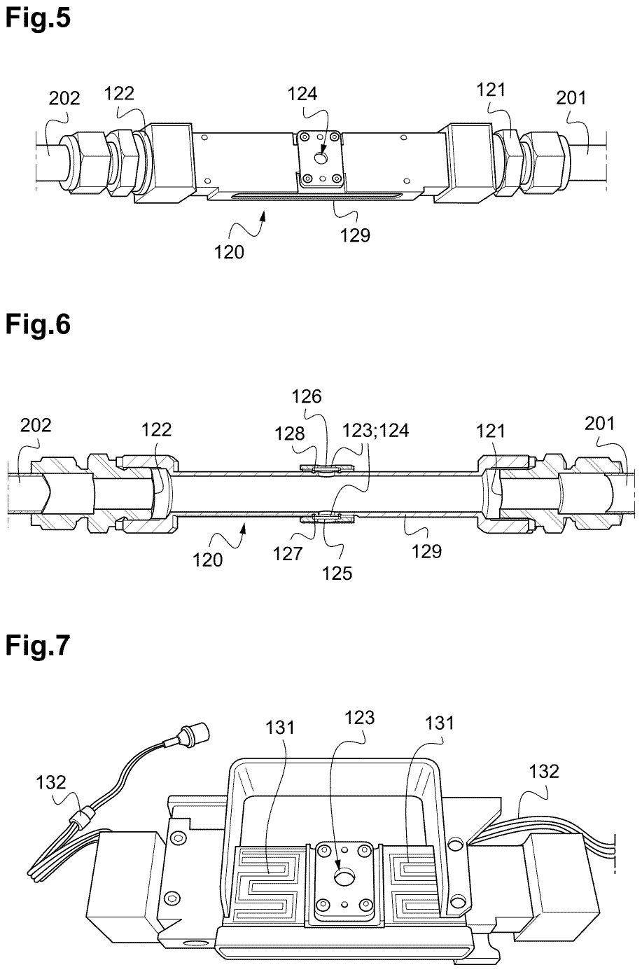

FIG. 5 is a schematic view of a measuring cell according to the present disclosure;

FIG. 6 is a cross-sectional schematic view of the measuring cell of FIG. 4;

FIG. 7 is a schematic view of part of the measuring cell of FIG. 6;

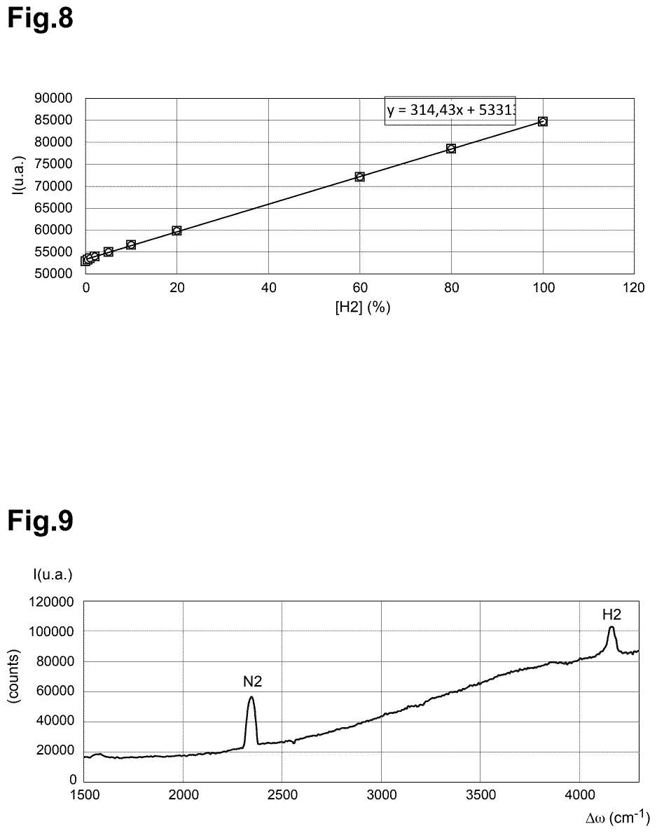

FIG. 8 is a diagram showing an example of calibration function of the spectrometer;

FIG. 9 is a diagram showing an example of spectral measurement acquired by the measuring system; and

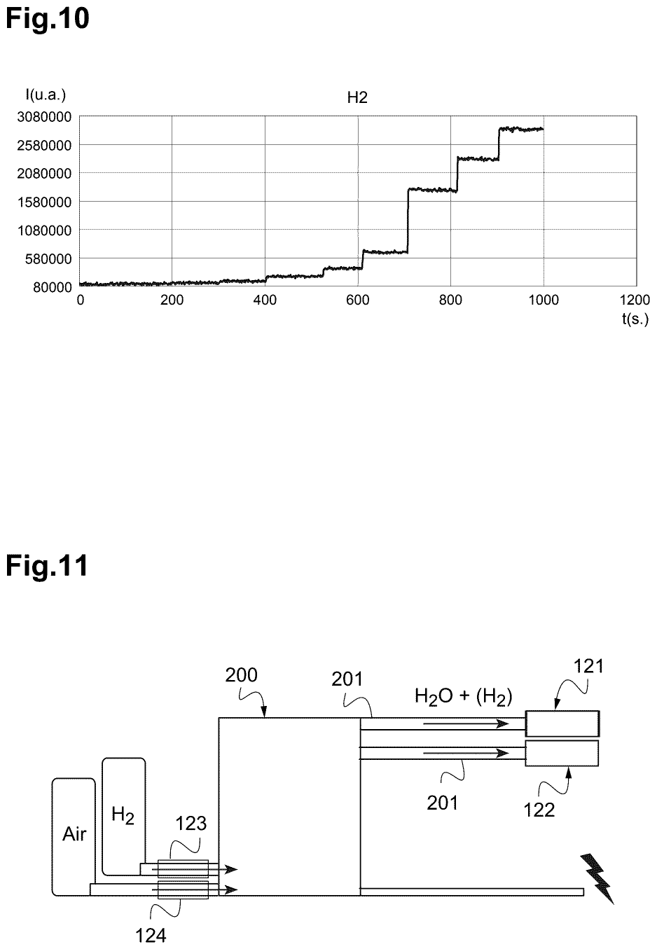

FIG. 10 is a diagram showing an example of evolution of a Raman signal representative of dihydrogen as a function of time;

FIG. 11 is a schematic view of a system with several measuring cells used for example in an electrochemical generator system of the fuel cell type.

FIG. 1 shows a schematic view of a measuring system 100 enabling in particular to measure concentrations of chemical components present in a flowing fluid 101. The fluid may be in gaseous or liquid form.

The measuring system 100 here comprises a Raman spectrometry apparatus 110, a double-pass measuring system 120, an optical device 130 and an optical system 140.

The measuring system is particularly adapted for measuring flowing fluids for an electrochemical generator system 200. The electrochemical generator system 200 can be used as an electrolyser. For example, the electrochemical generator system 200 is an electrolyser used for making hydrogen. The electrochemical generator system 200 then consumes electricity to produce hydrogen.

In another application, the electrochemical generator system 200 is used to generate electricity. In this case, the electrochemical generator system consumes a fuel, for example hydrogen, in order to produce electricity.

Advantageously, the Raman spectrometry apparatus is adapted for measuring the concentration of at least one chemical component among water, e.g. as water vapour, dinitrogen, dihydrogen and dioxygen.

The measuring system 100 is shown in use on an electrochemical generator system 200 of the fuel cell type in FIG. 2. In FIG. 2, the electrochemical generator system 200 of the electricity generator type. Air and dihydrogen are injected at the fuel cell inlet. The combustion generates electricity. At the outlet, the fluid is conveyed by two conduits 201, a conduit 201 on the anode, the other conduit 201 on the cathode of the fuel cell. A double-pass measuring cell 120 is arranged on at least one conduit 201 to measure the flowing fluid 101 leaving the fuel cell 200. Advantageously, each conduit 201 is fitted with a double-pass measuring cell 120 to detect simultaneously the fluids on the conduit 201 connected to the anode and, respectively, on the conduit 201 connected to the cathode.

Part of the measuring system 100 is shown in use in FIG. 4.

The Raman spectrometry apparatus 110 comprises an interface casing 115, a light source 111 and a Raman spectrometer 112.

The measurement principle is schematically shown in FIG. 3.

The light source 111 is configured to generate an excitation light beam 116.

The interface casing 115 is located as close as possible to the measuring cell 120. The interface casing 115 provides measurement interface with the measuring cell.

Preferably, the light source 111 is external to the interface casing 115 and the excitation light beam 116 is conveyed to the interface casing through a fibre-optic cable FO.E. The excitation light beam 116 is transmitted to the measuring cell 120 via the interface casing 115.

As an alternative, the light source 111 is positioned in the interface casing 115 of the Raman spectrometry apparatus 110.

Advantageously, as illustrated in FIG. 4, the double-pass measuring cell 120, the optical device 130, the optical system 140 and the interface casing 115 are integrated, for example on a plate forming an opto-mechanical support, to form a Raman probe 150 connected by optical fibres to the light source 111 and to the Raman spectrometer 112. That way, a single light source 111 and a single Raman spectrometer 112 can be connected to several local Raman probes 150 arranged at the inlet and/or the outlet of the electrochemical generator system 200.

The light source 111 is preferably a high-intensity laser. Here, the light source 111 is for example a laser with a power of 1.5 W that emits a monochromatic light beam with a wavelength of 532 nm. The light source is high power in order to obtain a Raman signal with a sufficiently high intensity to allow an integration time compatible with real-time monitoring, e.g. at a rate of about 1 Hz.

As an alternative, the excitation light beam is generated from any light source adapted for generating parts of the spectrum or the entire spectrum.

The measuring cell 120 comprises a fluid conduit 129 having an inlet opening 121 and an outlet opening 122, a first tight porthole 123 and a second tight porthole 124.

The inlet opening 121 is connected to a first flowing fluid-conveying conduit 201 and configured to let the flowing fluid 101 enter.

The outlet opening 122 is connected to a second flowing fluid-conveying conduit 202 and configured to let the flowing fluid 101 exit. The fluid conduit 129 guides the flowing fluid 101 entering via the inlet opening 121 towards the outlet opening 122.

In order not to generate any change in the pressure or flow rate of the flowing fluid 101, the cross-section of the inlet opening 121, the cross-section of the outlet opening 122 and the cross-section of the fluid conduit 129 are each greater than or equal to the cross-section of the flowing fluid-conveying conduits 201, 202.

For example, here, the conveying conduits 201, 202 and the measuring cell 120 have a circular cross-section, the inner diameter of the cross-section of the measuring cell 120 as well as those of the two inlet opening 121 and outlet opening 122 are of 16 mm and are identical to the inner diameter of the two conveying conduits 201, 202. The flowing fluid pressure in the measuring cell is then identical to the flowing fluid pressure in the conduits 201, 202. The flowing fluid total pressure in the conduits 201, 202 is for example of 2 bars.

The two portholes 123, 124 are arranged laterally on the fluid conduit 129, downstream from the inlet opening 121 and upstream from the outlet opening 122. The two portholes 123, 124 are positioned facing each other. For example, the fluid conduit 129 being of circular cross-section, two portholes 123, 124 are arranged diametrically opposite each other. In another example, the fluid conduit 129 being of square or rectangular cross-section, two portholes 123, 124 are arranged on two opposites faces of the fluid conduit 129. That way, the flowing fluid 101 passes between the two portholes 123, 124.

The measuring cell 120 is positioned so that the two portholes 123, 124 are on a main optical axis OA transverse to the flowing fluid.

The two portholes 123, 124 are configured to transmit the excitation light beam 116. For example, the excitation light beam propagates along a main lighting axis aligned on the main optical axis.

The two portholes 123, 124 are configured to transmit a first light beam 117 formed by scattering and/or simple transmission of the excitation light beam through the flowing fluid 101.

In other words, the measuring cell 120 is integrated to the flowing fluid-conveying conduits 201, 202 and then contains flowing fluid 101 ready to be measured thanks to the portholes, without needing extraction or deviation of the flowing fluid 101 out of the flow conduits 201, 202.

The measuring cell 120, shown in FIGS. 4 to 6, makes it possible to analyse the flowing fluid 101 without any change in pressure, humidity or temperature. Thus, the measurements are as close as possible to the real conditions of the flowing fluid 101 at fuel cell inlet or outlet. The measuring cell 120 has a very small footprint on the flow conduits 201,202.

In a first embodiment, the inlet opening of the measuring cell 120 is connected to a flowing fluid-conveying conduit at the outlet of the electrochemical generator system 200.

In a second embodiment, the outlet opening is connected to a flowing fluid-conveying conduit at the inlet of the electrochemical generator system 200.

Therefore, the measuring cell can be connected, for example, to the outlet or the inlet of the electrochemical generator system 200 in order to study the fluids entering or the fluids leaving the electrochemical generator system 200.

The first porthole 123 comprises a first glass sheet 125 and the second porthole 124 comprises a second glass sheet 126.

The panes of glass 125, 126 are preferably made from borosilicate or aluminosilicate glass or alkali-aluminosilicate glass. For example, the panes of glass 125, 126 are here made with BK7 or with Gorilla Glass. Preferably, the panes of glass 125, 126 have no surface coating on the side in contact with the flowing fluid 101. The composition and disposition of the panes of glass 125, 126 enables to prevent any outgassing or contamination of the flowing fluid by interaction between the flowing fluid and such a surface coating, liable to pollute the measurement.

The portholes 123, 124 are tight thanks to the use of gaskets. The measuring cell 120 comprises for example two gaskets 127, 128, a first gasket 127 positioned between the first glass sheet 125 and the fluid conduit 129, and a second gasket 128 between the second glass sheet 126 and the fluid conduit 129.

Like the material of the panes of glass 125, 126, the material of the gaskets 127, 128 must not pollute the measurement. For that purpose, the joints 127, 128 are manufactured using an inert component. The gaskets 127, 128 are here made from a fluoroelastomer material (commonly known as FKM or viton).

The panes of glass 125, 126 form cold points. These cold points on the passage of the flowing fluid 101 may cause condensation, in particular if the flowing fluid 101 contains water or water vapour.

The presence of condensation on the portholes 123, 124 may lead to a deterioration in the measurement quality, particularly as a result of a reduction in signal intensity or an increase in optical aberration.

According to a particular aspect, illustrated in FIG. 7, the measuring cell 120 comprises at least one thermal unit. The thermal unit is configured to maintain the first porthole and/or the second porthole at a temperature higher than or equal to a threshold temperature. Preferably, the measuring cell 120 comprises two thermal units 131 configured to maintain the two portholes 123, 124 at a temperature higher than or equal to the threshold temperature. The thermal units are powered by electrical cables 132.

The threshold temperature is defined as a function of the temperature of the flowing fluid 101. For example, the flowing fluid 101 is at a temperature of about 60 °C and the threshold temperature is of about 70 °C. The thermal unit thus makes it possible to prevent condensation forming on the portholes 123, 124.

The optical system 140 is arranged on the path of the excitation light beam 116, between the light source 111 and the first porthole 123. The optical system 140 is configured to focus the excitation light beam 116 in the flowing fluid 101 between the two portholes 123, 124 of the measuring cell 120. For example, the optical system 140 is a lens or an objective. The second porthole 124 transmits the first light beam 117, formed by scattering and/or simple transmission of the excitation light beam 116 through the flowing fluid 101, towards the optical device 130.

The optical device 130 is at least partially reflective. Preferably, the optical device 130 is a concave mirror. The optical device 130 is for example a spherical mirror arranged so that its centre of curvature is on the main optical axis OA, in the middle between the two panes of glass 123, 124.

The optical device 130 is positioned so as to receive the first light beam 117 transmitted by the second porthole 124. The reflective optical device 130 is positioned out of the measuring cell 120. This arrangement avoids any interaction between the flowing fluid 101 and a reflective coating, for example metallic, of the optical device 130, which enables to prevent any pollution of the flowing fluid 101.

The optical device 130 is configured to reflect the first light beam 117 and to form a reflected light beam 118 towards the flowing fluid 101 through the second porthole 124. The optical device 130 is configured to focus the reflected light beam 118 into the measuring cell between the two portholes. For example, the optical device 130 comprises a spherical mirror, preferably arranged so as to focus the reflected light beam 118 into the flowing fluid 101, in the middle between the two portholes 123, 124.

After having passed through the flowing fluid 101 and the first porthole 123, a second light beam 119 is obtained, which is formed by scattering and/or double transmission of the excitation light beam 116 through the flowing fluid 101 and the portholes 123, 124. The second light beam 119 propagates towards the optical system 140, which enables the second light beam 119 to be collected.

The association of the double-pass measuring cell 120 with the reflective optical device 130 enables a double excitation of the flowing fluid 101. Indeed, the excitation beam having passed through the measuring cell 120 is re-focused into the flowing fluid 101 and enables the excitation to be doubled. This optical configuration further has the advantage of doubling the solid collection angle by collecting the portion of the Raman signal that is emitted towards the Raman spectrometry apparatus but also that which is emitted towards the optical device 130 and which is then reflected and sent back towards the Raman spectrometry apparatus 110.

The double-pass term is linked to the round trip of the light beam in the measuring cell 120. However, the flowing fluid 101 passes only once through the measuring cell 120 in the flowing direction, without interruption of the flow.

The Raman spectrometer 112 comprises a detection system 113 and a processing system 114. The Raman spectrometer 112 is configured to receive the second light beam 119 comprising the Raman signals emitted by the flowing fluid 101.

Preferably, the Raman spectrometer 112 is external to the interface casing 115, that forms a local probe, and is connected to this local probe via a fibre-optic cable FO. S, as illustrated in FIGS. 1 and 4.

As an alternative, the Raman spectrometer 112 is integrated to the interface casing 115.

In order to avoid measurement pollution by air, the optical device 130 and the optical system 140 are positioned as close as possible to the measuring cell 120 so as to reduce the optical path of the light beams.

For the same reason, the external casing 115 collecting the signal is positioned as close as possible to the optical system 140.

The Raman spectrometer 112 is adapted to detect, in the second light beam 119, a Raman signal emitted by the flowing fluid 101. The Raman signal is emitted in particular thanks to the excitation of the flowing fluid 101 by the excitation light beam 116 and by the reflected light beam 118.

The Raman spectrometer 112 generally comprises a diffraction grating and a light sensor 113.

The diffraction grating is for example formed of straight, parallel and regularly spaced lines. The diffraction grating is for example a reflective network positioned so as to receive and reflect the light beam entering the Raman spectrometer 112, and to form a light beam diffracted into different wavelengths of the spectrum.

The diffracted light beam is generally focused on the light sensor 113 using the diffraction grating or using an optical focusing system such as a mirror or a lens.

The light sensor 113 comprises for example pixels arranged along one or several rows.

The rows of pixels are generally oriented in the spectral diffraction direction of the diffracted light beam image. Preferably, each row comprises the same number of pixels arranged in column so that the pixels form a matrix on the light sensor.

As an alternative, the Raman spectrometry apparatus 110 comprises a second light source adapted to emit a second excitation light beam, and the light sensor is configured to detect simultaneously the Raman signal 119 induced by the light source and a second Raman signal emitted by the flowing fluid 101 when the flowing fluid 101 is excited by the second light source.

The processing system 114 is adapted to deduce a measurement of at least one chemical component of the flowing fluid 101 from the Raman signal detected by the detection system 113.

The processing system 114 allows the light sensor to be read and at least one spectrum to be deduced therefrom. The at least one spectrum is for example obtained by summing part of the pixels of a same column.

Preferably, the Raman spectrometry apparatus enables acquisition of one spectrum every second, in order to monitor the flowing fluid 101 in real time.

FIG. 9 shows an example of Raman spectrum measured that way. On the Raman spectrum of FIG. 9, an intensity I of the measured signal is represented as a function of the Raman offset Δω (in cm-1). The measured signal has a peak at about 2300 cm⁻¹, corresponding to dinitrogen. The measured signal has another peak at about 4100 cm⁻¹, corresponding to dihydrogen.

The intensity of the measured Raman signal depends on the concentration of the elements present, the pressure value and the power of the excitation beam. The processing system 114 is configured to calculate the concentration of the desired chemical components using the measured signal and a calibration function. The calibration function makes it possible to establish a function between the measured Raman signal of a chemical component and the concentration of this chemical component.

A calibration function for converting the measured signal intensity into dihydrogen concentration is shown in FIG. 8.

The calibration function is determined for example using the measurement of a standard fluid at given concentrations.

For example, in FIG. 10, a fluid comprising dihydrogen at a predetermined and variable concentration has been measured by the measuring system 100. The measured signal includes several plates each corresponding to a different concentration. The dihydrogen concentration corresponding to the plate between instant t=0 and instant t of about 308 s. is equal to 0%. The dihydrogen concentration corresponding to the plate between instant t of about 308 s. and instant t of about 400 s. is equal to 2%. The dihydrogen concentration corresponding to the plate between instant t of about 400 s. and instant t of about 520 s. is equal to 5%. The dihydrogen concentration corresponding to the plate between instant t of about 520 s. and instant t of about 610 s. is equal to 10%. The dihydrogen concentration corresponding to the plate between instant t of about 610 s. and instant t of about 710 s. is equal to 20%. The dihydrogen concentration corresponding to the plate between instant t of about 710 s. and instant t of about 810 s. is equal to 60%. The dihydrogen concentration corresponding to the plate between instant t of about 810 s. and instant t of about 910 s. is equal to 80%. The dihydrogen concentration corresponding to the plate between instant t of about 910 s. and instant t of about 1000 s. is equal to 100%. The curve thus represents the intensity of a Raman signal for a fluid comprising a concentration of between 0 and 100% of dihydrogen.

This curve makes it possible to establish the calibration function presented in FIG. 8.

This curve also allows the accuracy of the measurement to be established. For the example shown in FIG. 10, an accuracy of measurement of about 5% is observed. The measuring system 100 provides accuracy up to 0.2%.

The calibration function can also be used to take into account the ageing of the measuring system 100, such as a decrease in the intensity of the light source 111 or a decrease in the transmission of the components used (the portholes 123, 124, the optical device 130 and the optical system 140). Generally, the calibration function is updated at regular intervals or when necessary.

The measuring system 100 also makes it possible to detect polluting chemical components. For example, the processing system 114 is configured to detect signals in the spectrum that do not correspond to the chemical elements expected in the flowing fluid 101.

For example, the intensity of the Raman signal corresponding to dihydrogen and dinitrogen is measured simultaneously as a function of time. Monitoring the evolution of the Raman signal over time makes it possible to monitor and record the various events occurring in the electrochemical generator system 200 of the fuel cell type, in particular a hydrogen fuel cell that generates electricity. Events may include load increases, fluctuations in fluid supply, or unloading of the electrochemical generator system 200.

FIG. 11 illustrates a multi-point measuring system based on the use of several measuring cells. Such a measuring system makes it possible to measure simultaneously the chemical composition of at least one fluid at several inlet and/or outlet points of an electrochemical generator system comprising a plurality of fluid inlet and/or outlet conduits 201. The multi-point measuring system applies in particular to a fuel cell or to an electrolyser. For example, a fuel cell includes two inlet fluid conduits 201: an inlet conduit 201 being adapted for injection of air and another inlet conduit 201 being adapted for injection of dihydrogen. The fuel cell also includes two fluid outlet conduits 201: an outlet conduit 201 on the anode, the other outlet conduit 201 on the cathode of the fuel cell.

For that purpose, the measuring system includes a plurality of double-pass measuring cells 1201, 1202, 1203, 1204 each arranged on a fluid inlet or outlet conduit 201 of the electrochemical generator system. The plurality of measuring cells includes two, three, four or more than four measuring cells. In an example, the measuring system includes a measuring cell 1201 on an outlet conduit 201 and another measuring cell 1202 on another outlet conduit 201. In an example, the measuring system includes a measuring cell 1201 on an outlet conduit 201 and another measuring cell 1203 on a dihydrogen inlet conduit 201. In another example, the measuring system includes a measuring cell 1201 on an outlet conduit 201 and another measuring cell 1203 on an oxygen inlet conduit 201. In another example, the measuring system includes a measuring cell 1203 on a dihydrogen inlet conduit 201 and another measuring cell 1204 on an oxygen inlet conduit 201. In still another example, the measuring system includes a measuring cell 1203 on a dihydrogen inlet conduit 201, another measuring cell 1204 of an oxygen inlet conduit 201, a measuring cell 1201 on an outlet conduit 201 and another measuring cell 1202 on another outlet conduit 201. A controller makes it possible to activate the measurement of several measuring cells among the measuring cells installed on the conduits.

The multi-point measuring system also includes a Raman spectrometry apparatus 110 comprising a light source 111, a Raman spectrometer 112 including a detection system 113 and a processing system 114. The light source 111 is configured to generate an excitation light beam 116. Advantageously, a beam splitter is arranged so as to receive the excitation light beam 116 and to form a plurality of split excitation light beams. For example, a beam splitter is used. Each split excitation light beam is directed, for example through optical fibre, towards one measuring cell among the plurality of measuring cells. This configuration makes it possible to use the same light source 111 for the measurements of the plurality of measuring cells, all operating at the same source wavelength. As an alternative, several light sources are used, each light source generating an excitation light beam directed towards a measuring cell.

Each measuring cell 1201, 1202, 1203, 1204 is configured as described hereinabove, for example in relation with FIG. 3, on a specific inlet or outlet conduit of the electrochemical generator system. Each measuring cell 1201, 1202, 1203, 1204 is adapted for receiving a split excitation light beam and transmitting a first light beam formed by scattering and/or simple transmission of the split excitation light beam through the flowing fluid 101 in the considered fluid conduit. As described hereinabove, the at least partially reflective optical device 130 of each fluid cell is positioned so as to receive the first light beam transmitted by the two portholes and configured to reflect the first light beam towards the flowing fluid through the two portholes 123, 124 to form a second light beam formed by scattering and/or double transmission of the excitation light beam through the flowing fluid 101 and the two portholes 123, 124.

The Raman spectrometer 112 is configured to receive separately the second light beam of each double-pass measuring cell 1201, 1202, 1203, 1204, for example via optical fibre. Advantageously, the optical fibres carrying the second light beam of each measuring cell 1201, 1202, 1203, 1204 are arranged in line along the elongated direction of the inlet slot of the Raman spectrometer 112. The detection system preferably comprises an imaging detector adapted for detecting separately a Raman signal corresponding to each second light beam coming from each measuring cell 1201, 1202, 1203, 1204. The detection system thus makes it possible to detect separately on different areas of the imaging detector the Raman signal emitted by the flowing fluid of each double-pass measuring cell. Advantageously, the detection of different Raman signals coming from different measuring cells is simultaneous. The processing system is adapted to deduce therefrom a measurement of at least one chemical component of the flowing fluid in each double-pass measuring cell 1201, 1202, 1203, 1204. Such a multi-point measuring system allows the chemical composition of the fluid to be measured at several inlet and/or outlet points of the electrochemical generator system 200 at low cost. Particularly advantageously, the system includes as many measuring cells as fluid inlet and outlet conduits, which makes it possible to measure simultaneously, in real time and in a non-intrusive manner, all the fluid inlets and outlets of the electrochemical generator system 200. Such a system provides information about the operation of the electrochemical generator system 200.

In particular, in a fuel cell, it is particularly advantageous to have a measuring cell 1203 on the anode-side inlet conduit, a measuring cell 1204 on the cathode-side inlet conduit, a measuring cell 1201 on the anode-side outlet conduit, a measuring cell 120 on the cathode-side outlet conduit. The measuring cells 1201, 1203 on the inlet and outlet anodes can be used to monitor the chemical composition of the fluids, in particular dihydrogen, dinitrogen, water (H₂O), carbon dioxide (CO₂) and carbon monoxide (CO). The measuring cells 1202, 1204 on the inlet and outlet cathodes can be used to monitor the chemical composition of the fluids, in particular dihydrogen, dinitrogen and water (H₂O). These measurements performed simultaneously and in real time make it possible to evaluate the fuel cell efficiency, to perform stress measurements on the fuel cell, modelling or simulations, or also improvements of the fuel cell.

The multi-point measuring system can be similarly applied to monitor simultaneously and in real time, in a non-intrusive manner, the fluid inlets and outlets of an electrolyser.

The present invention is not in any way limited to the embodiment described and shown, but the person skilled in the art will know how to apply any variant in accordance with the invention.

1. A measuring system (100) for measuring at least one chemical component of a flowing fluid (101) for an electrochemical generator system (200), the measuring system comprising:
a Raman spectrometry apparatus (110) comprising a light source (111), a Raman spectrometer (112) comprising a detection system (113) and a processing system (114), the light source (111) being configured to generate an excitation light beam (116),
a double-pass measuring cell (120) comprising a fluid conduit (129) having an inlet opening (121) configured to let the flowing fluid (101) enter and an outlet opening (122) configured to let the flowing fluid (101) exit, the measuring cell (120) comprising a first tight porthole (123) and a second tight porthole (124), the two portholes (123, 124) being arranged laterally on the fluid conduit (129) downstream from the inlet opening (121) and upstream from the outlet opening (122), the two portholes (123, 124) being positioned facing each other on a main optical axis transverse to the fluid conduit and being configured to receive the excitation light beam and transmit a first light beam formed by scattering and/or simple transmission of the excitation light beam through the flowing fluid in the fluid conduit (101), and
an at least partially reflective optical device (130) positioned so as to receive the first light beam transmitted by the two portholes (123, 124) and configured to reflect the first light beam towards the flowing fluid (101) through the two portholes (123, 124) to form a second light beam (119) formed by scattering and/or double transmission of the excitation light beam through the flowing fluid (101) and the two portholes (123, 124),
the Raman spectrometer (112) being configured to receive the second light beam (119), the detection system (113) being adapted for detecting a Raman signal emitted by the flowing fluid (101) and the processing system (114) being adapted for deducing a measurement of at least one chemical component of the flowing fluid (101).

2. The measuring system (100) according to claim 1, wherein the measuring cell

(120) is connected to an outlet of an electrochemical generator system (200) of the electrolyser type, in particular for hydrogen generation, and wherein the Raman spectrometry apparatus (110) is adapted for measuring the concentration of at least one chemical component among water, dinitrogen, dihydrogen and dioxygen.

3. The measuring system (100) according to claim 1, wherein the outlet opening (122) of the measuring cell (120) is connected to an inlet or an outlet of an electrochemical generator system (200) of the hydrogen fuel cell type, and wherein the Raman spectrometry apparatus (110) is adapted for measuring the concentration of at least one chemical component among water, dinitrogen, dihydrogen and dioxygen.

4. The measuring system (100) according to claim 1, wherein the inlet opening (121) or the outlet opening (122) of the measuring cell (120) is connected via a flowing fluid-conveying conduit (201; 202) to the electrochemical generator system (200).

5. The measuring system (100) according to claim 4, wherein the inlet opening (121) cross-section and the outlet opening (122) cross-section of the measuring cell (120) are each greater than or equal to the cross-section of the flowing fluid-conveying conduit (201, 202) of the electrochemical generator system (200).

6. The measuring system (100) according to claim 1, comprising an optical system (140) arranged between the light source (111) and the first porthole (123), the optical system (140) being configured to focus the excitation light beam into the measuring cell (120), between the two portholes (123, 124).

7. The measuring system (100) according to claim 1, wherein the at least partially reflective optical device (130) is configured to reflect and focus the first light beam into the measuring cell (120), between the two portholes (123, 124).

8. The measuring system (100) according to claim 1, wherein the measuring cell (120) comprises at least one thermal unit (131) configured to maintain the first porthole (123) and/or the second porthole (124) at a temperature higher than or equal to a threshold temperature.

9. The measuring system (100) according to claim 1, wherein the first porthole (123) comprises a first glass sheet and the second porthole (124) comprises a second glass sheet, wherein the first, respectively second, glass sheet is made from a glass among borosilicate glass or alkali-aluminosilicate glass.

10. The measuring system (100) according to claim 1, comprising a second measuring cell and wherein the Raman spectrometry apparatus (110) comprises a second light source adapted for emitting a second excitation light beam, the detection system (113) comprising a light sensor including pixels arranged in several rows and configured to detect simultaneously the Raman signal induced by the light source (111) and a second Raman signal emitted by the flowing fluid (101) when the flowing fluid (101) is excited by the second excitation light beam.

11. A measuring system for measuring at least one chemical component of a flowing fluid (101) for an electrochemical generator system (200) comprising a plurality of fluid inlet and/or outlet conduits (201), the measuring system comprising:
a Raman spectrometry apparatus (110) comprising a light source (111), a Raman spectrometer (112) comprising a detection system (113) and a processing system (114), the light source (111) being configured to generate an excitation light beam (116), a beam splitter arranged so as to receive the excitation light beam (116) and to form a plurality of split excitation light beams,
a plurality of double-pass measuring cells (1201, 1202, 1203, 1204) each arranged on a fluid inlet or outlet conduit (201) of the electrochemical generator system, each double-pass measuring cell (1201, 1202, 1203, 1204) comprising a fluid conduit (129) having an inlet opening (121) configured to let enter the flowing fluid coming from said fluid inlet or outlet conduit (201) of the electrochemical generator system (200) and an outlet opening (202) configured to let the flowing fluid exit, each measuring cell (1201, 1202, 1203, 1204) comprising a first tight porthole (123) and a second tight porthole (124), the two portholes (123, 124) of each measuring cell (1201, 1202, 1203, 1204) being arranged laterally on the fluid conduit downstream from the inlet opening and upstream from the outlet opening, the two portholes (123, 124) of each measuring cell (1201, 1202, 1203, 1204) being positioned facing each other on a main optical axis transverse to the fluid conduit and being configured to receive a split excitation light beam and transmit a first light beam formed by scattering and/or simple transmission of the excitation light beam through the flowing fluid (101) in the fluid conduit, and
an at least partially reflective optical device (130) positioned so as to receive the first light beam transmitted by the two portholes and configured to reflect the first light beam towards the flowing fluid through the two portholes (123, 124) to form a second light beam formed by scattering and/or double transmission of the excitation light beam through the flowing fluid (101) and the two portholes (123, 124),
the Raman spectrometer (112) being configured to receive separately the second light beam from each double-pass measuring cell (1201, 1202, 1203, 1204), the detection system being adapted for detecting separately a Raman signal emitted by the flowing fluid of each double-pass measuring cell and the processing system being adapted for deducing therefrom a measurement of at least one chemical component of the flowing fluid in each double-pass measuring cell (1201, 1202, 1203, 1204).

12. The measuring system (100) according to claim 2, wherein the inlet opening (121) or the outlet opening (122) of the measuring cell (120) is connected via a flowing fluid-conveying conduit (201; 202) to the electrochemical generator system (200).

13. The measuring system (100) according to claim 3, wherein the inlet opening (121) or the outlet opening (122) of the measuring cell (120) is connected via a flowing fluid-conveying conduit (201; 202) to the electrochemical generator system (200).

14. The measuring system (100) according to claim 2, wherein the measuring cell (120) comprises at least one thermal unit (131) configured to maintain the first porthole (123) and/or the second porthole (124) at a temperature higher than or equal to a threshold temperature.

15. The measuring system (100) according to claim 3, wherein the measuring cell (120) comprises at least one thermal unit (131) configured to maintain the first porthole (123) and/or the second porthole (124) at a temperature higher than or equal to a threshold temperature.

16. The measuring system (100) according to claim 4, wherein the measuring cell (120) comprises at least one thermal unit (131) configured to maintain the first porthole (123) and/or the second porthole (124) at a temperature higher than or equal to a threshold temperature.

17. The measuring system (100) according to claim 2, wherein the first porthole (123) comprises a first glass sheet and the second porthole (124) comprises a second glass sheet, wherein the first, respectively second, glass sheet is made from a glass among borosilicate glass or alkali-aluminosilicate glass.

18. The measuring system (100) according to claim 3, wherein the first porthole (123) comprises a first glass sheet and the second porthole (124) comprises a second glass sheet, wherein the first, respectively second, glass sheet is made from a glass among borosilicate glass or alkali-aluminosilicate glass.

19. The measuring system (100) according to claim 2, comprising a second measuring cell and wherein the Raman spectrometry apparatus (110) comprises a second light source adapted for emitting a second excitation light beam, the detection system (113) comprising a light sensor including pixels arranged in several rows and configured to detect simultaneously the Raman signal induced by the light source (111) and a second Raman signal emitted by the flowing fluid (101) when the flowing fluid (101) is excited by the second excitation light beam.

20. The measuring system (100) according to claim 3, comprising a second measuring cell and wherein the Raman spectrometry apparatus (110) comprises a second light source adapted for emitting a second excitation light beam, the detection system (113) comprising a light sensor including pixels arranged in several rows and configured to detect simultaneously the Raman signal induced by the light source (111) and a second Raman signal emitted by the flowing fluid (101) when the flowing fluid (101) is excited by the second excitation light beam.
